(19) United States
(12) Patent Application Publication
(10) Pub. No.: US 2007/0291839 A1
(43) Pub. Date: Dec. 20, 2007

(54) METHOD AND DEVICE FOR MULTIMEDIA PROCESSING

(75) Inventor: Jhy-Neng Yeh, Taoyuan County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: FARADAY TECHNOLOGY CORP., Hsin-Chu City (TW)

(21) Appl. No.: 11/424,310

(22) Filed: Jun. 15, 2006

(51) Int. Cl. H04N 7/12; H04N 11/04

(52) U.S. Cl. 375/240.12; 375/240.24

(57) ABSTRACT

A multimedia processing method for data transformation, comprising performing a motion compensation process on an input macroblock to generate a motion compensated macroblock and storing the motion compensated macroblock into a system memory; moving the motion compensated macroblock from the system memory into a first internal memory bank; performing the deblocking operation on the motion compensated macroblock to generate a deblocked macroblock, a first plurality of pixels and a second plurality of pixels, wherein the first pixels are adjacent to an upper edge of the deblocked macroblock; storing the deblocked macroblock into the first internal memory bank to overwrite the motion compensated macroblock, and storing the first pixels and the second pixels into a second internal memory bank; performing the data format transformation operation on the upper pixels of the deblocked macroblock and the first pixels to generate a data transformed macroblock; and storing the data transformed macroblock into the system memory.

### BACKGROUND OF THE INVENTION

1. Field of the Invention

The present invention relates to multimedia processing method, and in particular relates to a method for combining a deblocking operation and a data format transformation operation.

2. Description of the Related Art

FIG. 1 is a schematic view of a conventional multimedia processing device, comprising data format transformation units 12 and 18, encoder 14 and decoder 16. When multimedia processing must be performed on YUV format data, data format transformation is required to convert an image into YUV format. Data format transformation unit 12 performs a data format transformation on an RGB input to convert the data format from RGB to YUV and generates YUV input data. Encoder 14 encodes the YUV input data and generates an encoded YUV data. Decoder 16 decodes the encoded YUV data and decoded YUV data is generated by motion compensation (MC) processing unit 20 of decoder 16. Data format transformation unit 18 performs the data format transformation on the decoded YUV data to convert the data format from YUV to RGB and generates decoded RGB data, since the format of the display image is RGB format.

The encoder and decoder are used for digital compression and decompression of multimedia data (e.g., according to Joint Photographic Experts Group (JPEG) or Moving Picture Expert Group (MPEG) industry standard data). However, when used at relatively low bit rates, the output of the decoder module produces noticeable coding artifacts, such as blockiness and ringing. These artifacts are undesirable and caused by attenuation of high frequency terms. With blockiness artifacts, the boundaries of coded blocks are visible in slow-varying regions in image or video frames.

However, in the decoded YUV data generated by MC processing unit 20, unwanted blocking artifacts often occur and smoothness is lost between adjacent blocks in the images.

### BRIEF SUMMARY OF INVENTION

A detailed description is given in the following embodiments with reference to the accompanying drawings.

An embodiment of a multimedia processing method for data transformation, comprises: performing a motion compensation process on an input macroblock to generate a motion compensated macroblock and storing the motion compensated macroblock into a system memory; moving the motion compensated macroblock from the system memory into a first internal memory bank; performing the deblocking operation on the motion compensated macroblock to generate a deblocked macroblock, a plurality of first pixels and a plurality of second pixels, wherein the first plurality of pixels is adjacent to an upper edge of the deblocked macroblock; storing the deblocked macroblock into the first internal memory bank to overwrite the motion compensated macroblock, and storing the first pixels and the second pixels into a second internal memory bank; performing the data format transformation operation on the upper pixels of the deblocked macroblock and the first pixels to generate a data transformed macroblock; and storing the data transformed macroblock into the system memory.

Another embodiment of a multimedia processing device for data transformation comprises: a motion compensation processing unit for performing a motion compensation process on an input macroblock to generate a motion compensated macroblock, wherein the motion compensated macroblock is stored in a system memory; a deblocking unit for performing a deblocking operation on the motion compensated macroblock according to lower pixels of a previous macroblock row and a previous macroblock stored in a second internal memory bank to generate a deblocked macroblock and a first plurality of pixels, wherein the deblocked macroblock is stored into a first internal memory bank to overwrite the motion compensated macroblock and the first pixels are stored into the second internal memory bank, wherein the first plurality of pixels is adjacent to an upper edge of the deblocked macroblock; and a data format transformation unit for performing a data format transformation on the deblocked macroblock and the first pixels to generate a data transformed macroblock, wherein the data transformed macroblock is stored into the system memory.

### BRIEF DESCRIPTION OF DRAWINGS

The present invention can be more fully understood by reading the subsequent detailed description and examples with references made to the accompanying drawings, wherein:

FIG. 1 is a schematic view showing a conventional multimedia processing device.

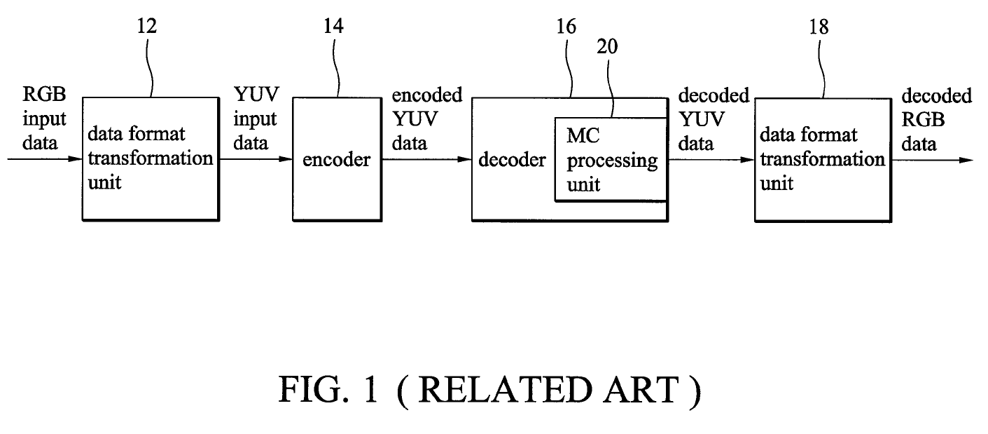

FIG. 2 is a schematic view showing a multimedia processing device of the invention.

FIG. 3 is a flowchart showing an embodiment of a method for effectively performing an MC process, deblocking operation and data format transformation using a multimedia processing device.

FIG. 4 is a schematic diagram showing a ping-pong buffer of the invention comprising the first internal memory bank-A, the first internal memory bank-B and the second internal memory bank.

FIG. 5 is a schematic diagram showing the modified sequence for deblocking a macroblock.

FIG. 6 is a schematic diagram showing a frame.

### DETAILED DESCRIPTION OF INVENTION

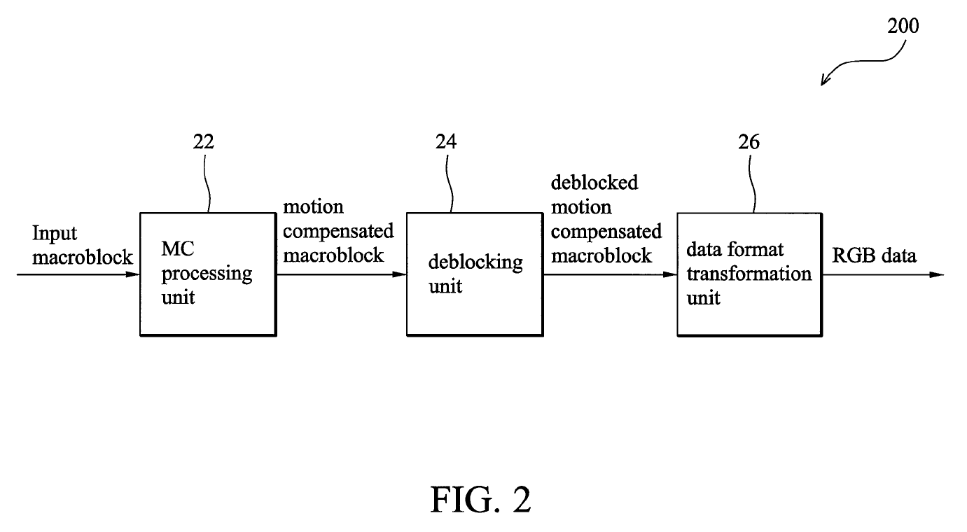

FIG. 2 is a schematic diagram showing multimedia processing device 200 of the invention comprising motion compensation (MC) processing unit 22, deblocking unit 24 and data format transformation unit 26. MC processing unit 22 performs a MC process on an input macroblock and generates a motion compensated macroblock. Deblocking unit 24 performs the deblocking operation on the motion compensated macroblock and generates the deblocked motion compensated macroblock. Data format transformation unit 26 converts the deblocked motion compensated macroblock from YUV420 format to RGB format.

Note that in block-based coding schemes such as MPEG 4, blocking artifacts often occur and smoothness is lost between adjacent blocks in the images. Deblocking techniques are used to restore image smoothness.

Note that motion-compensated prediction assumes that the current picture can be locally modeled as a translation of the pictures at some previous time. In the MPEG 4 standard, each picture is divided into blocks of 16×16 pixels. Each macroblock is predicted from the previous or future frame, by estimating the amount of the motion in the macroblock during the frame time interval. The MPEG 4 syntax specifies how to represent the motion information for each macroblock.

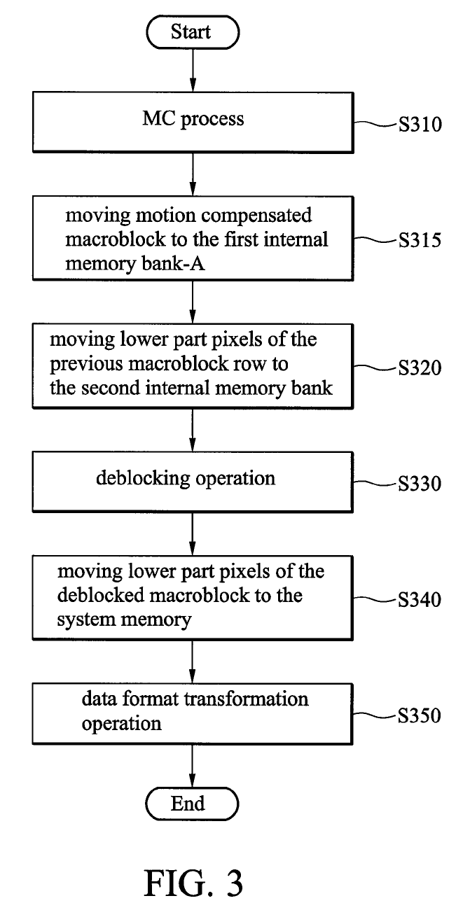

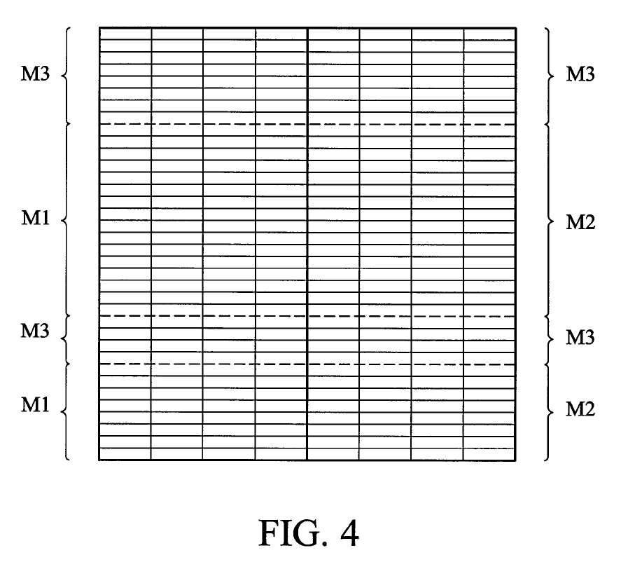

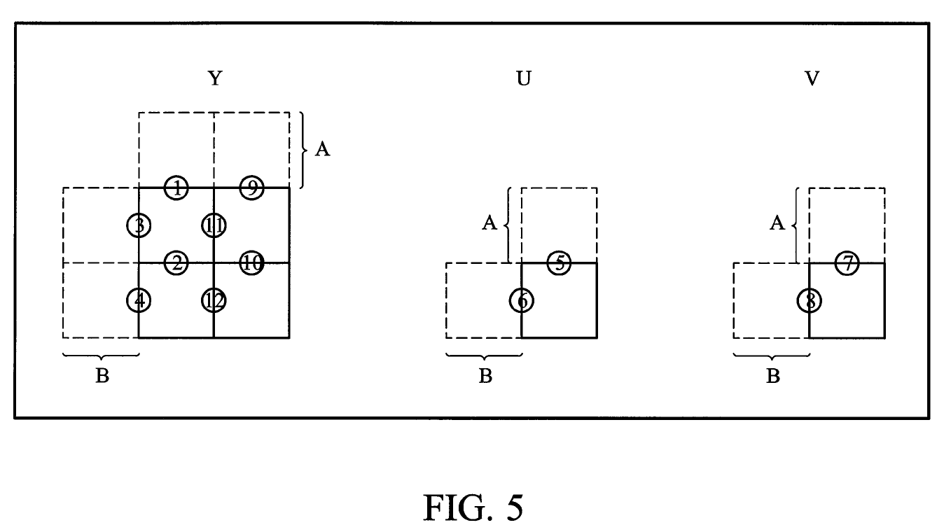

FIG. 3 is a flowchart showing an embodiment of a method for effectively performing an MC process, deblocking operation and data format transformation using multimedia processing device 200. In step S310, MC processing unit 22 performs an MC process on an input macroblock and a motion compensated macroblock is generated. Note that the data format of the input macroblock is, YUV 420 and the macroblock by macroblock processing method is adopted by MPEG 4 standard. The motion compensated macroblock is stored in a system memory (not shown). In step S315, the motion compensated macroblock is moving from the system memory in to a first internal memory bank-A M1 (as shown in FIG. 4). In step S320, a lower part of the pixels of a previous macroblock row (as shown in FIG. 5) adjacent to the input macroblock is moved from the system memory to a second internal memory bank M3 (as shown in FIG. 4). In step S330, deblocking unit 24 performs the deblocking operation on the motion compensated macroblock and a deblocked macroblock, a plurality of first pixels A and a plurality of second pixels B is generated. Note that the deblocking operation is performed to reduce blocking artifacts and an 8-pixel deblocking operation is adopted in this embodiment of the invention. The deblocked macroblock is stored in the first internal memory bank-A M1 to overwrite the motion compensated macroblock. The lower part of the pixels of the previous macroblock row and a previous macroblock stored in the second internal memory bank M3 are overwritten by the first pixels A and the second pixels B. In step S340, the lower part of the deblocked macroblock is moved from the first internal memory bank-A M1 to the system memory for the deblocking operation of the next macroblock row. For the benefit of the data format transformation, the lower part of Y of the deblocked macroblock are 8*16 pixels, while the lower part of U and V of the deblocked macroblock are 4*8 pixels. However, only 4*16 pixels of the lower part of Y of the deblocked macroblock are used in the, deblocking operation. In step S350, data format transformation unit 26 performs the data format transformation operation on the first part pixels A and the upper part of the deblocked macroblock to transform the format of the macroblock from YUV420 to RGB and a data transformed macroblock is generated. Note that the format of the data transformed macroblock is RGB. The data transformed macroblock is stored into the system memory.

The 8 pixel deblocking operation is described in the following:

Assume that the eight pixels are v₁, v₂, V₃, V₄, v₅, v₆, V₇, v₈, respectively. A mode decision value eq_cnt is then calculated according to the equation

eq_{—}cnt=+φ(v₁−v₂)+φ(v₂−v₃)+φ(v_{3i -v}₄)+φ(v₄−v₅)+φ(v₅−v₆)+φ(v₆−v₇)+φ(v₇−v₈)

where φ(r)=1, if |r|≦THR1, otherwise φ(r=0,

wherein THR1 is a first predetermined value defined by one skilled in the art. Mode decision value eq_cnt is compared with a second predetermined value THR2 defined by one skilled in the art to determine the computing mode. The computing mode can be a default mode or a DC offset mode. The DC offset mode is selected when the mode decision value eq_cnt is greater than or equal to the second predetermined value THR2, otherwise the default mode is selected.

When the default mode is selected, the deblocking operation is performed by replacing the magnitude of the discontinuous component of pixel v₄ and v₅ sandwiching the block boundary with v₄′ and v₅′, according to the following equation:

v₄′=v₄−d

v₅′=v₅+d

d=CLIP(c₂·(a_{3,0}′−a_{3,0})//c_{3,0},(v₄−v₅)/2)*δ(|a_{3,0}|<QP

a_{3,0}′=SIGN(a_{3,0})*MIN(|a_{3,0}|,|a_{3,1}|,|a_{3,2}|))

a_{3,0}=([c₁−c₂c₂−c₁]*[v₃v₄v₅v₆]^{T})//c₃

a_{3,1}=([c₁−c₂c₂−c₁]*[v₁v₂v₃v₄]T)//c₃

a_{3,2}=([c₁−c₂c₂−c₁]*[v₅v₆v₇v₈]T)//c₃

wherein QP is the quantization parameter of a macroblock to which pixel v₅ belongs, values c₁, c₂, c₃ are kernel constants used in 4-point DCT, and a_{3,0}, a_{3,1}, a_{3,2} are the discontinuous component in each of the plurality of pixel sets (S0, S1, S2), respectively.

When the DC offset mode is selected, the equation to remove the blocking artifacts is as follows:

$$max = MAX ( {v}_{1} , {v}_{2} , {v}_{3} , {v}_{4} , {v}_{5} , {v}_{6} , {v}_{7} , {v}_{8} ) , \\ min = MIN ( {v}_{1} , {v}_{2} , {v}_{3} , {v}_{4} , {v}_{5} , {v}_{6} , {v}_{7} , {v}_{8} ) , \\ if \vert max = min \vert < 2 \cdot QP , \\ then {v}_{n}^{′} = {\sum }_{k = - 4}^{4} {b}_{k} \cdot {p}_{n + k} , 1 \leq n \leq 8$$

$${p}_{m} = \{ \begin{matrix}( \vert {v}_{2} - {v}_{1} \vert < QP ) ? {v}_{1} \text{:} {v}_{2} , m < 1 \\ {v}_{m} , 1 \leq m \leq 8 \\ ( \vert {v}_{7} - {v}_{8} \vert < QP ) ? {v}_{g} \text{:} {v}_{7} , m > 8\end{matrix} \\ \{ {b}_{k} : - 4 \leq k \leq 4 \} = \{ 1 , 1 , 2 , 2 , 4 , 2 , 2 , 1 , 1 , \} // 16$$

wherein the v₀-v₉ are boundary pixels, QP is the quantization parameter of a block adjacent the block boundary, and vₙ is an adjusted value. The deblocking operation is performed by replacing pixels v₁-v₈ with v₁′-v₈′.

FIG. 4 is a schematic diagram showing a ping-pong buffer comprising the first internal memory bank-A M1, the first internal memory bank-B M2 and the second internal memory bank M3. The deblocking operation and the data format transformation operation of different pipeline can be performed simutaniously by using the ping-pong buffer. While the first internal memory bank-A M1 is used to perform the deblocking operation, the first internal memory bank-B M2 is used to perform the data format transformation operation and vise versa.

FIG. 5 is a schematic diagram showing the modified sequence for deblocking a macroblock. Note that the macroblock is composed of four blocks of Y, one block of U′ and one block of V. Note that the macroblock has 12 deblocking edges comprising a first edge 1, a second edge 2, a third edge 3, a fourth edge 4, a fifth edge 5, a sixth edge 6, a seventh edge 7, a eighth edge 8, a ninth edge 9, a tenth edge 10, a eleventh edge 11 and a twelfth edge 12. The modified deblocking sequence of the macroblock is to perform the deblocking operation on the first edge 1, the second edge 2, the third edge 3, the fourth edge 4, the fifth edge 5, the sixth edge 6, the seventh edge 7, the eighth edge 8, the ninth edge 9, the tenth edge 10, the eleventh edge 11 and the twelfth edge 12 in turn. The deblocking operation on the first edge 1, the second edge 2, the third edge 3, the fourth edge 4, the fifth edge 5, the sixth edge 6, the seventh edge 7 and the eighth edge 8 are performed in advance, since that will change the pixel values of the previous macroblock and the lower part of the pixels of the previous macroblock row. Therefore, the deblocking operation and the data format transformation can be effectively performed in pipeline. Note that the modified deblocking sequence also satisfies the standard defined in MPEG 4 standard section F.3 for performing deblocking operations on horizontal edges before horizontal edges.

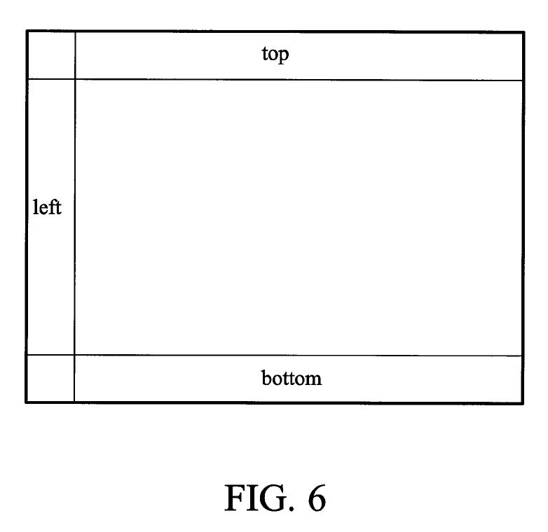

FIG. 6 is a schematic diagram showing a frame. Each macroblock of the first macroblock row of the frame is marked as top, the left macroblock of each macroblock row of the frame is marked as left, and each macroblock of the last macroblock row of the frame is marked as bottom.

The deblocking operation on the first edge 1, the fifth edge 5, the seventh edge 7 and the ninth edge 9 are unnecessary while the input macroblock is marked as top. Therefore only the deblocking operation on the second edge 2, the third edge 3, the fourth edge 4, the sixth edge 6, the eighth edge 8, the tenth edge 10, the eleventh edge 11 and the twelfth edge 12 are performed in turn.

In addition, the deblocking operation on the third edge 3, the fourth edge 4, the sixth edge 6 and the eighth edge 8 are unnecessary while the input macroblock is marked as left. Therefore, only the deblocking operation on the first edge 1, the second edge 2, the fifth edge 5, the seventh edge 7, the ninth edge 9, the tenth edge 10, the eleventh edge 11 and the twelfth edge 12 are performed in turn.

Additionally, the first macroblock of the first macroblock row is marked as both top and left, therefore the deblocking operation on the first edge 1, the third edge 3, the fourth edge 4, the fifth edge 5, the sixth edge 6, the seventh edge 7, the eighth edge 8 and the ninth edge 9 are unnecessary. Therefore, only the deblocking operation on the second edge 2, the tenth edge 10, the eleventh edge 11 and the twelfth edge 12 are performed in turn.

Noted that the step S340 of moving the lower part of the deblocked macroblock from the first internal memory bank-A M1 to the system memory is unnecessary when the input macroblock is marked as bottom as it is at the last macroblock row of the frame.

Since the modified sequence of the deblocking operation has high regularity, the software can be simplified to effectively perform both deblocking and data format transformation operations. Further, since each macroblock of the last macroblock row marked as bottom are performed by the data format transformation unit automatically without moving the lower part of the deblocked macroblock from the first internal memory bank-A M1 to the system memory, the software load is reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multimedia processing method for data transformation, comprising:
performing a motion compensation process on an input macroblock to generate a motion compensated macroblock and storing the motion compensated macroblock into a system memory;
moving the motion compensated macroblock from the system memory into a first internal memory bank;
performing a deblocking operation on the motion compensated macroblock to generate a deblocked macroblock, a plurality of first pixels and a plurality of second pixels, wherein the first pixels are adjacent to an upper edge of the deblocked macroblock;
storing the deblocked macroblock into the first internal memory bank to overwrite the motion compensated macroblock, and storing the first pixels and the second pixels into a second internal memory bank;
performing a data format transformation on a plurality of upper pixels of the deblocked macroblock and the first pixels to generate a data transformed macroblock; and
storing the data transformed macroblock into the system memory.

2. The multimedia processing method as claimed in claim 1, wherein the deblocked macroblock having a first edge, a second edge, a third edge, a fourth edge, a fifth edge, a sixth edge, a seventh edge, an eighth edge, a ninth edge, a tenth edge, an eleventh edge and a twelfth edge.

3. The multimedia processing method as claimed in claim 2, further comprising moving the lower pixels of the deblocked macroblock from the first internal memory bank to the system memory before performing the data format transformation.

4. The multimedia processing method as claimed in claim 3, wherein the deblocking operation is performed on the first edge, the second edge, the third edge, the fourth edge, the fifth edge, the sixth edge, the seventh edge, the eighth edge, the ninth edge, the tenth edge, the eleventh edge and the twelfth edge of the deblocked macroblock in turn.

5. The multimedia processing method as claimed in claim 3, wherein the deblocking operation is only performed on the second edge, the third edge, the fourth edge, the sixth edge, the eighth edge, the tenth edge, the eleventh edge and the twelfth edge of the deblocked macroblock in turn when the deblocked macroblock is marked as top.

6. The multimedia processing method as claimed in claim 3, wherein the deblocking operation is only performed on the first edge, the second edge, the fifth edge, the seventh edge, the ninth edge, the tenth edge, the eleventh edge and the twelfth edge of the deblocked macroblock in turn when the deblocked macroblock is marked as left.

7. The multimedia processing method as claimed in claim 3, wherein the deblocking operation is only performed on the second edge, the tenth edge, the eleventh edge and the twelfth edge of the deblocked macroblock in turn when the deblocked macroblock is marked as both top and left.

8. The multimedia processing method as claimed in claim 4, wherein the step of moving the lower pixels of the deblocked macroblock from the first internal memory bank to the system memory is unnecessary when the deblocked macroblock is marked as bottom.

9. The multimedia processing method as claimed in claim 1, further comprising moving the lower pixels of a previous macroblock row from the system memory to the second internal memory bank after storing the motion compensated macroblock into the first internal memory bank.

10. The multimedia processing method as claimed in claim 1, wherein the data, format transformation operation is to convert YUV420 format of the data transformed macroblock to RGB format.

11. The multimedia processing method as claimed in claim 1, wherein the first internal memory bank and the second internal memory bank together form a ping-pong buffer.

12. A multimedia processing device for data transformation, comprising:
a motion compensation processing unit for performing a motion compensation process on an input macroblock to generate a motion compensated macroblock, wherein the motion compensated macroblock is stored in a system memory;
a deblocking unit for performing a deblocking operation on the motion compensated macroblock according to the lower pixels of a previous macroblock row and a previous macroblock stored in a second internal memory bank to generate a deblocked macroblock and a plurality of first pixels, wherein the deblocked macroblock is stored into a first internal memory bank to overwrite the motion compensated macroblock and the first pixels are stored into the second internal memory bank, wherein the first pixels are adjacent to an upper edge of the deblocked macroblock; and
a data format transformation unit for performing a data format transformation operation on the deblocked macroblock and the first pixels to generate a data transformed macroblock, wherein the data transformed macroblock is stored into the system memory.

13. The multimedia processing device as claimed in claim 12, wherein the deblocked macroblock having a first edge, a second edge, a third edge, a fourth edge, a fifth edge, a sixth edge, a seventh edge an eighth edge, a ninth edge, a tenth edge, an eleventh edge and a twelfth edge.

14. The multimedia processing device as claimed in claim 12, further comprising moving the motion compensated macroblock from the system memory into the first internal memory bank before performing the deblocking operation.

15. The multimedia processing method as claimed in claim 13, further comprising moving the lower pixels of the deblocked macroblock from the first internal memory bank to the system memory before performing the data format transformation.

16. The multimedia processing device as claimed in claim 15, wherein the deblocking operation is performed on the first edge, the second edge, the third edge, the fourth edge, the fifth edge, the sixth edge, the seventh edge, the eighth edge, the ninth edge, the tenth edge, the eleventh edge and the twelfth edge of the deblocked macroblock in turn.

17. The multimedia processing device as claimed in claim 15, wherein the deblocking operation is only performed on the second edge, the third edge, the fourth edge, the sixth edge, the eighth edge, the tenth edge, the eleventh edge and the twelfth edge of the deblocked macroblock in turn when the deblocked macroblock is marked as top.

18. The multimedia processing device as claimed in claim 15, wherein the deblocking operation is only performed on the first edge, the second edge, the fifth edge, the seventh edge, the ninth edge, the tenth edge, the eleventh edge and the twelfth edge of the deblocked macroblock in turn when the deblocked macroblock is marked as left.

19. The multimedia processing device as claimed in claim 15, wherein the deblocking operation is only performed on the second edge, the tenth edge, the eleventh edge and the twelfth edge of the deblocked macroblock in turn when the deblocked macroblock is marked as both top and left.

20. The multimedia processing device as claimed in claim 16, wherein the step of moving the lower pixels of the deblocked macroblock from the second internal memory bank to a system memory is unnecessary when the deblocked macroblock is marked as bottom.

21. The multimedia processing method as claimed in claim 12, further comprising moving the lower pixels of the previous macroblock row from the system memory to the second internal memory bank after moving the motion compensated macroblock into the first internal memory bank.

22. The multimedia processing device as claimed in claim 12, wherein the data format transformation operation is to convert YUV420 format of the data transformed macroblock to RGB format.

23. The multimedia processing method as claimed in claim 12, wherein the first internal memory bank and the second internal memory bank together form a ping-pong buffer.
